(19) United States
(12) Patent Application Publication
(10) Pub. No.: US 2015/0082962 A1
(43) Pub. Date: Mar. 26, 2015

(54) FENCE WITH AUXILIARY POSITIONING DEVICE FOR A SAW MACHINE

(71) Applicant: REXON INDUSTRIAL CORP. LTD., Taichung (TW)

(72) Inventor: Chun Teng LIN, Taichung (TW)

(73) Assignee: REXON INDUSTRIAL CORP., LTD., Taichung (TW)

(21) Appl. No.: 14/492,528

(22) Filed: Sep. 22, 2014

(30) Foreign Application Priority Data
Sep. 23, 2013 (TW) 102134129

(51) Int. Cl. B27B 27/10; B27B 27/04

(52) U.S. Cl. CPC B27B 27/10; B27B 27/04
USPC 83/468.7

(57) ABSTRACT

A fence with auxiliary positioning device for a saw machine adapted for installation on a worktable having a front portion and an opposite rear portion. The worktable has a plane for supporting a workpiece. The fence includes a base disposed on the rear portion and at least one auxiliary positioning device. The base includes at least one panel, and the panel has a first planar surface which extends toward the front portion and is perpendicular to the plane. The auxiliary positioning device includes a fixing member and a positioning post. The fixing member is disposed on the base and is parallely slidable relative to the first planar surface, and the positioning post is disposed on the fixing member. The positioning post is convertible relative to the panel between a collapsed position and an extended position having a second planar surface which is perpendicular to the first planar surface and the plane.

### FIELD OF THE INVENTION

The present invention relates to a saw machine, and more specifically, to a fence with auxiliary positioning device for a saw machine.

### BACKGROUND

Referring to FIGS. 1 and 2, which disclose a fence for a saw machine, the fence for the saw machine includes base 11 mounted to a worktable 10 of the saw machine, a fence panel 12 which is pivotally mounted to the base 11, a plurality of connecting holes 13 are spacedly defined along a longitudinal direction of the base 11, and an auxiliary member 14 detachably insertable into any one of the connecting hole 13.

During operation, a workpiece 15 is placed on the worktable 10, at least one end of the workpiece 15 abuts against either the base 11 or the fence panel 12, then, the auxiliary member 14 inserts into the connecting hole 13 which is proximate to the workpiece 15 such that another end of the workpiece 15 abuts against the auxiliary member 14. Thereby, a user merely needs to use one hand to hold and secure the workpiece 15, and the stability of the cutting operation is enhanced. The auxiliary member 14 may also be applied when cutting a plurality of workpieces to same length.

However, positions of the auxiliary member 14 are confined by the arrangement of the connecting holes 13, and thus, the auxiliary member 14 is not widely applicable to workpieces of various sizes. Further, since the auxiliary member 14 is detachably inserted into the connecting hole 13, the stability of the structure is relatively weak, and the auxiliary member 14 may fall off from the connecting hole 13 due to the vibration of the workpiece 15 when the cutting operation is performed. In addition, since the auxiliary member 14 is detachably insertable into the connecting hole 13, the auxiliary member 14 may be easily lost or broken due to frequently inserting into or disengaging from the connecting hole 13, or when transporting the saw machine. Therefore, the freedom to operate, stability and convenience of the structure still need to be improved.

Another type of fence device for a saw machine is disclosed in U.S. Pat. No. 5,337,641 and U.S. Pat. No. 5,768,966, which has a track disposed on a fence panel adapted for accommodating a sliding seat, and an L-shaped auxiliary member pivotally mounted to the sliding seat. This sliding track design enhances the freedom to operate and reduces the loss of the auxiliary member. However, since the shape of the auxiliary member is fixed, when the auxiliary member is retracted, it is flipped to a top of the fence panel. Therefore, the sliding seat needs to be loosened to remove the auxiliary member from the cutting unit to prevent the auxiliary member from interfering with the cutting operation. Thus, the drawbacks of this conventional design are that the operational steps are complicated and inconvenient to use.

### SUMMARY OF THE INVENTION

The present invention has been accomplished under the circumstances in view. It is therefore the main object of the present invention to provide a fence with auxiliary positioning device with enhanced operability and convenience.

To achieve these and other objects of the present invention, the fence with auxiliary positioning device in accordance with the present invention is adapted for mounting to a worktable of a saw machine. The worktable has a front portion and a rear portion opposite to the front portion, and includes a plane for supporting a workpiece. The fence with auxiliary positioning device comprises a base and at least one auxiliary positioning device.

The base is disposed on the rear portion of the worktable. The base has at least one panel disposed thereon. The panel has a first planar surface formed thereon. The first planar surface extends toward the front portion and is substantially perpendicular to the plane of the worktable.

The auxiliary positioning device has a fixing member disposed on the base and parallely slidable relative to the first planar surface. A column-shaped positioning post is disposed on the fixing member. The positioning post is convertible relative to the panel between an extended configuration and a collapsed configuration. In the extended configuration, the positioning post is oriented toward the front portion and extends beyond the first planar surface such that a second planar surface which is perpendicular to the first planar surface is formed on the positioning post. In the collapsed configuration, the positioning post is retracted and oriented toward the rear portion of the worktable such that the positioning post does not extend beyond the first planar surface.

Since the fixing member is parallely slidable relative to the first planar surface, the position of the fixing member can be steplessly adjusted for co-operating with workpieces of different lengths. In addition, the positioning post of the fixing member is convertible relative to the panel between the extended configuration and the collapsed configuration. The positioning post can be retracted to the collapsed configuration when not in use, thereby improving the stability of the cutting operation. In addition, the operating steps of the auxiliary positioning device are reduced compared to that of the conventional design such that the operability and convenience are greatly enhanced.

### BRIEF DESCRIPTION OF THE DRAWINGS

Advantages and features of the present invention will be understood by reference to the following specification in conjunction with the accompanying drawings, in which like reference numbers denote like elements of structure and component parts.

FIG. 1 is a perspective view of a conventional fence device for a saw machine.

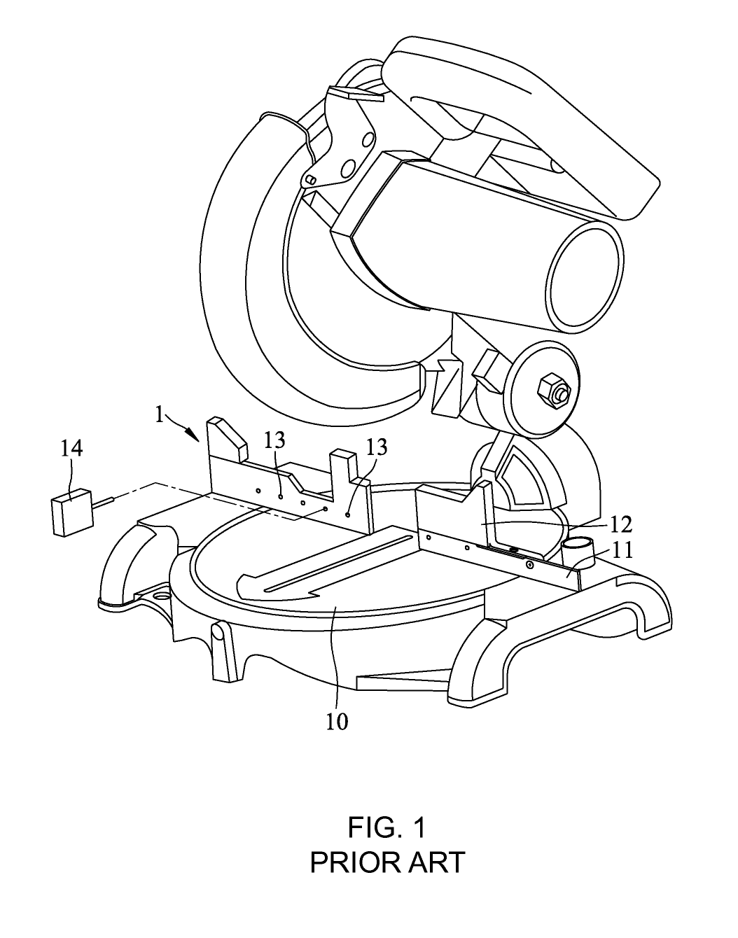

FIG. 2 is a perspective view of the conventional fence device of FIG. 1 in use.

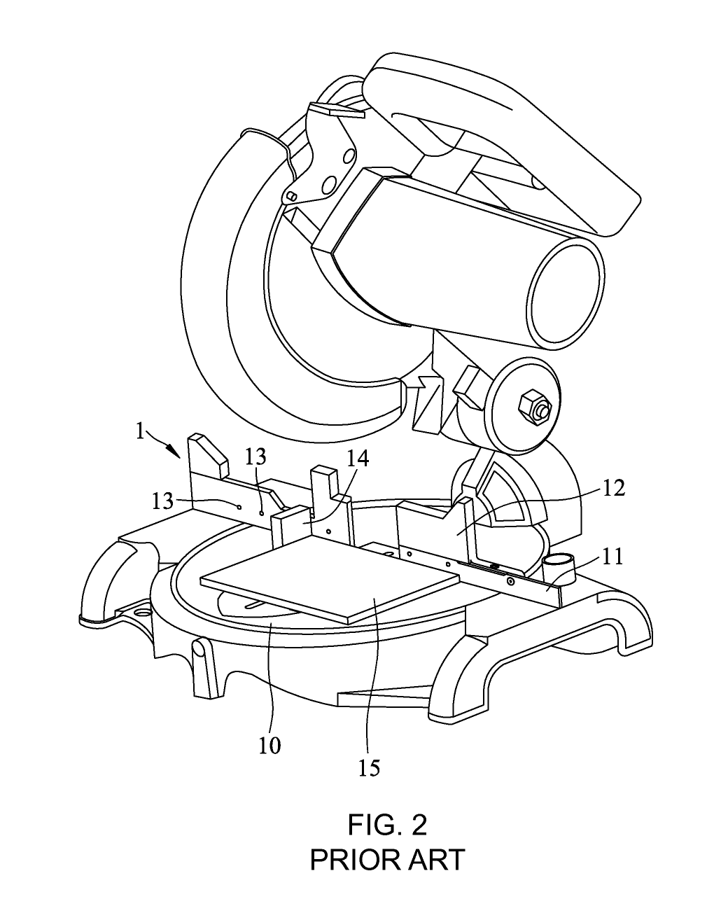

FIG. 3 is an exploded perspective view of a fence with auxiliary positioning device for a saw machine in accordance with a first embodiment of the present invention.

FIG. 4 is a front view of the first embodiment in accordance with the present invention.

FIG. 5 is a top view of the first embodiment in accordance with the present invention.

FIG. 6 is a perspective view of the first embodiment in accordance with the present invention in an operating state.

FIG. 7 is a perspective view of the first embodiment in accordance with the present invention in an operating state.

FIG. 8 is an exploded perspective view of the fence with auxiliary positioning device for a saw machine in accordance with a second embodiment of the present invention.

FIG. 9 is a perspective view of the second embodiment in accordance with the present invention in an operating state.

FIG. 10 is a perspective view of the second embodiment in accordance with the present invention in an operating state.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments of the present invention and the components thereof, and in no way limits the structures, configurations and components thereof according to the present disclosure.

### DETAILED DESCRIPTION

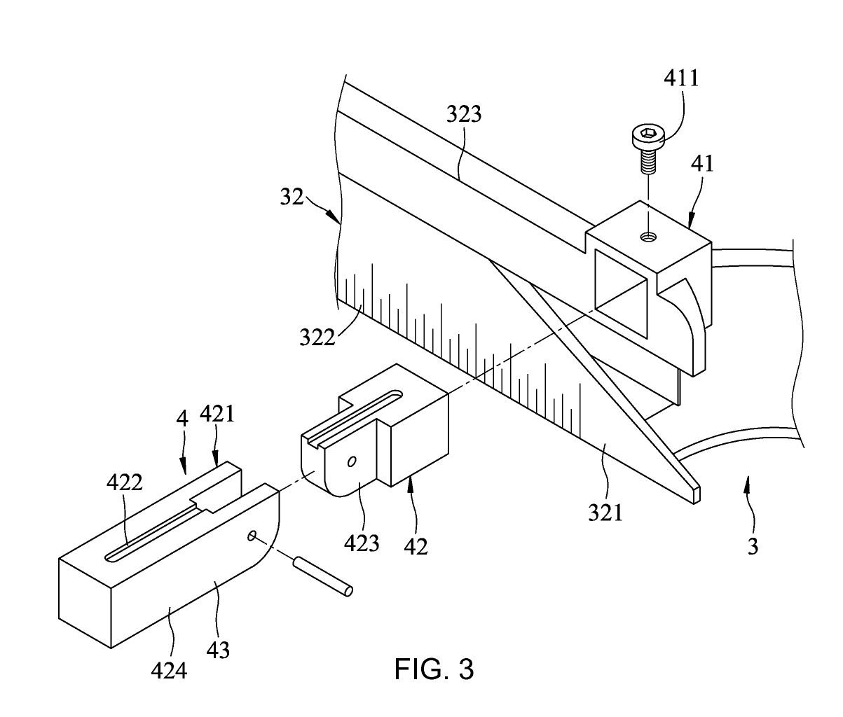

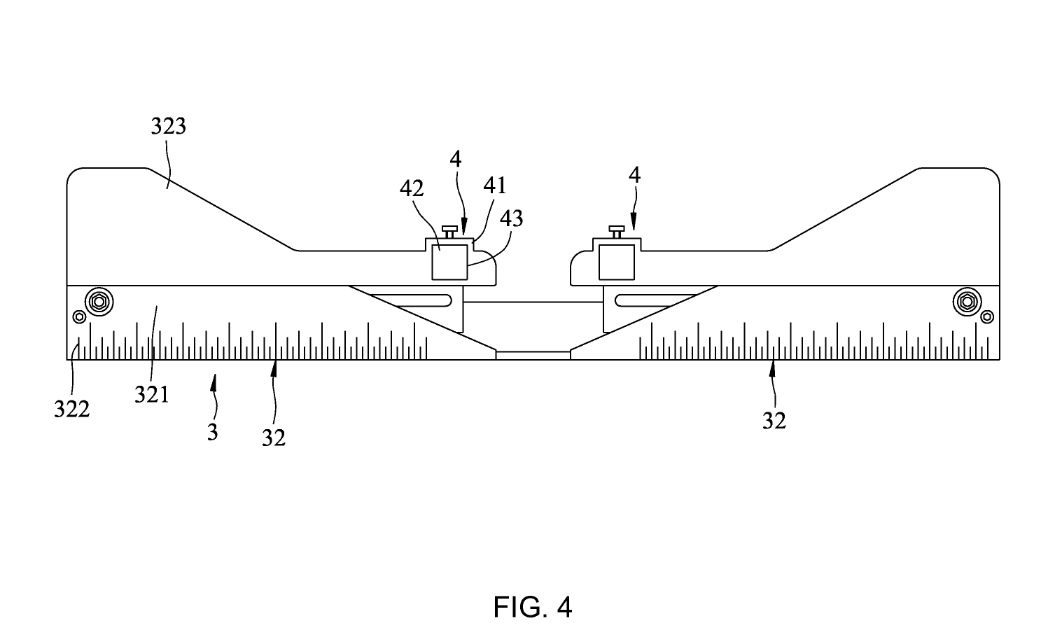

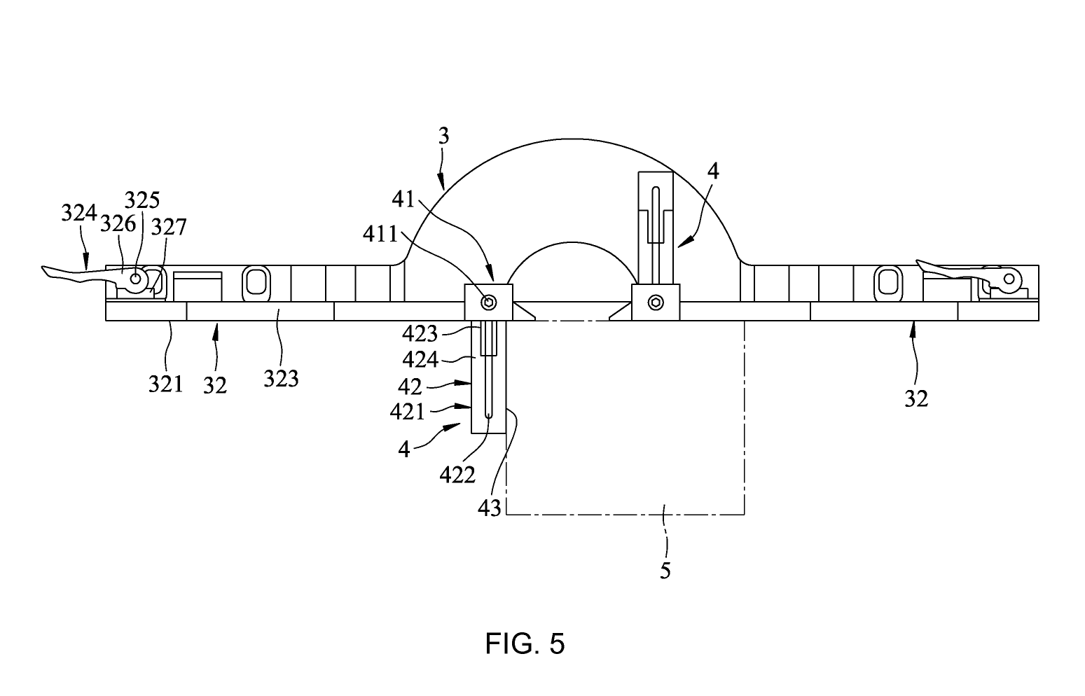

Referring to FIGS. 3-6, a preferred embodiment of the fence with auxiliary positioning device for a saw machine in accordance with the present invention is adapted for installing to a worktable 20 of a saw machine 2. The worktable has a front portion 21, a rear portion 22 opposite to the front portion 21, and a plane 23 for supporting a workpiece 5. The fence with auxiliary positioning device includes a base 3 which is disposed on the rear portion 22 of the worktable 20 and at least one auxiliary positioning device 4. In the present embodiment, in order to accommodate both right handed and left handed users, two auxiliary positioning devices 4 are adapted, however, it should be understood that only one auxiliary positioning device 4 may be adapted.

The base 3 includes at least one panel 32 disposed on the base 3. To circumvent the traveling path of a cutting unit 24 of the circular saw 2, two panels 32 which are spacedly arranged are applied in the present embodiment.

Each panel 32 has a first planar surface 321, a lower panel 322, an upper panel 323, and a locking member 324. The first planar surface 321 faces toward the front portion 21 and is substantially perpendicular to the plane 23 of the worktable 20. The lower panel 322 is secured to the base 3, the upper panel 323 is slidably disposed on the lower panel 322, and the locking member 324 is disposed on the base 3. Together the upper panel 322 and the lower panel 323 form the first planar surface 321.

Each locking member 324 has a positioning pin 325, a cam member 326, and a press member 327. The positioning pin 325 is disposed on the base 3 and is parallel to the first planar surface 321. The cam member 326 is pivotally mounted to the positioning pin 325. The press member 327 is sandwiched between the upper panel 323 and the cam member 326.

The cam member 326 is rotatable relative to the positioning pin 325 for selectively compressing the press member 327, such that the press member 327 urges the upper panel 323 to abut against the lower panel 322 for positioning the upper panel 323 relative to the lower panel 322.

Each auxiliary positioning device 4 comprises a fixing member 41 and a positioning post 42. The fixing member 41 is disposed on the upper panel 323 and is slidable on the upper panel 323 along a direction parallel to the first planar surface 321.

Each fixing member 41 has a locking post 411. In the present embodiment, for example, the locking post 411 is a threaded bolt.

Each positioning post 42 is column-shaped and includes a column member 421. The column member 421 has a coupling member 423 which is disposed on the fixing member 41 and a blocking member 424 which is pivotally engaged to the coupling member 423. A positioning slot 422 is longitudinally defined along the column member 421 for slidably accommodating the locking post 411.

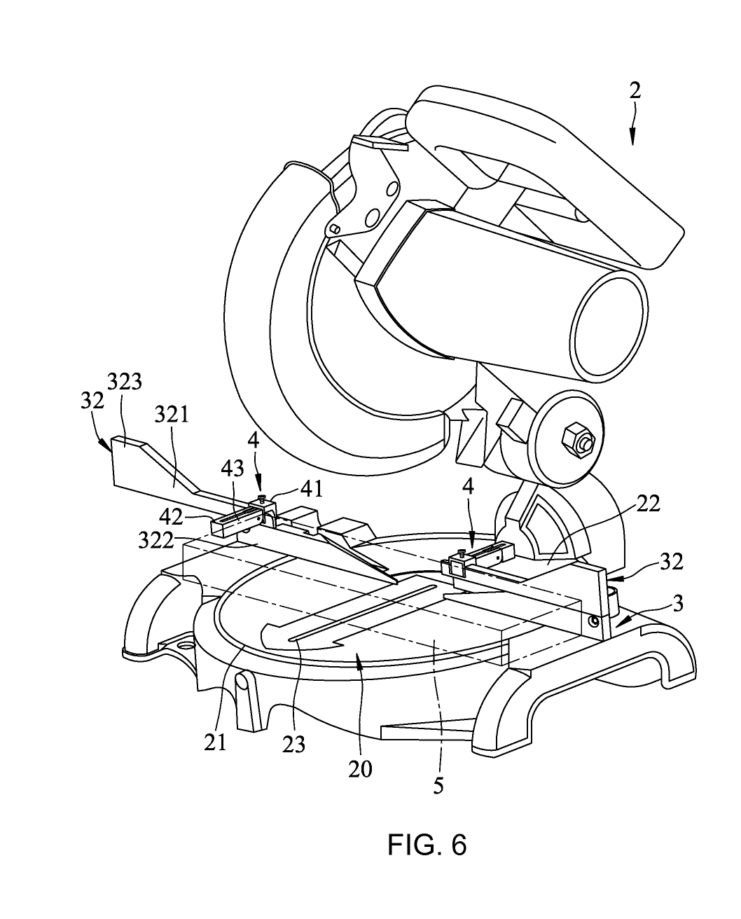

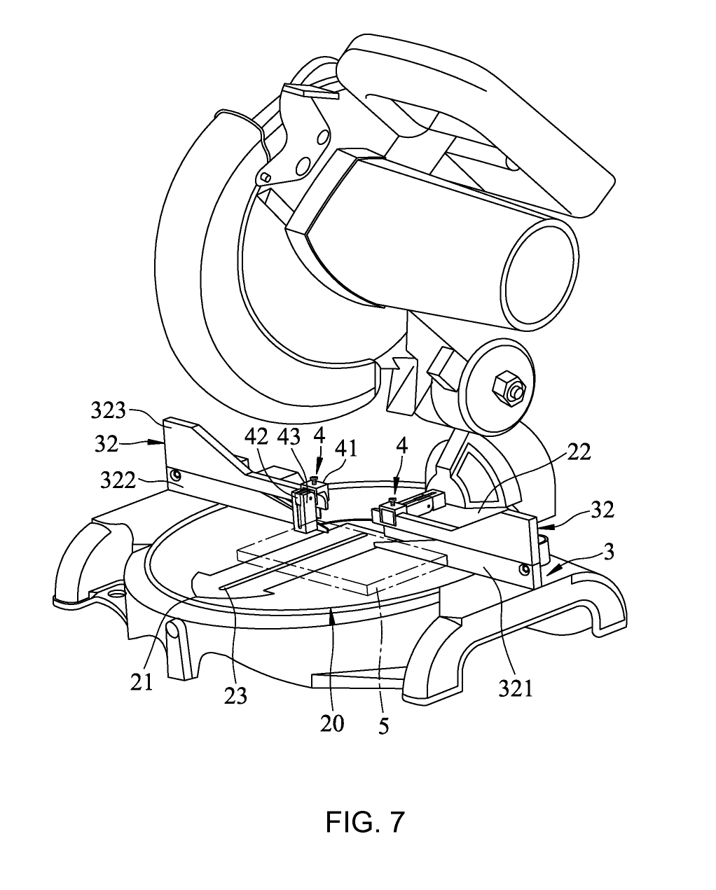

Referring to FIGS. 6-7, the positioning posts 42 are respectively convertible relative to the panel 32 between an extended configuration and a collapsed configuration. In the extended configuration, the positioning post 42 is oriented toward the front portion 21 and extends beyond the first planar surface 321 such that a second planar surface 43 which is perpendicular to the first planar surface 321 and the plane 23 of the worktable 20 is formed. The first planar surface 321 and the second planar surface 43 provide support to adjacent lateral edges of the workpiece 5, such that the stability for cutting operation is enhanced. In the collapsed configuration, the positioning post 42 is retracted and oriented toward the rear portion 22 of the worktable 20 such that the positioning post 42 does not extend beyond the first planar surface 321. Therefore the workpiece 5, which does not need extra support from the auxiliary positioning device 4, may stably abut against the first planar surface 321 for the cutting operation.

In addition, since the positioning posts 42 are individually operable, a left-handed user may manually move the positioning post 42 located on the left hand side to the extended configuration, retract the positioning post 42 located on the right hand side to the collapsed configuration, and adjust the upper panel 323 on the left side to an appropriate position, such that the user may use his right hand to hold the workpiece 5 for performing the cutting operation. Conversely, a right-handed user may move the positioning post 42 located on the right hand side to the extended configuration, and retract the positioning post 42 on the left hand side to the collapsed configuration, and adjust the upper panel 323 on the right hand side to the appropriate position, such that the user may use his left hand to hold the workpiece 5 for performing the cutting operation.

When cutting workpieces 5 of various thickness, the positioning post 42 is converted to the extended configuration, and the blocking member 424 is pivotally rotatable relative to the coupling member 423 between a first position and a second position. In the first position, the blocking member 424 longitudinally extends from the coupling member 423 and is located away from the worktable 20 for supporting workpiece 5 which has greater size and thickness (as shown in FIG. 6). In the second position, the blocking member 424 is substantially perpendicular to the coupling member 423, and is located proximate to the worktable for supporting the workpiece 5 which is smaller in size and thickness (as shown in FIG. 6).

In view of the above, the fixing member 41 of the present invention is slidably disposed on the upper panel 323 for sliding along the direction parallel to the first planar surface 321. In addition, the variable positions of the blocking member 424 allows stepless adjustment adapted for supporting workpiece 5 of various sizes and thicknesses. Further, as previously mentioned, when more than one auxiliary positioning device 4 in accordance with the present invention is applied, each auxiliary positioning device 4 is individually operable, and since the positioning post 42 is column-shaped, when the positioning post 42 is not in use and retracted to the collapsed position, the size of the positioning post 42 is compact to prevent it from interfering with the cutting operation. Therefore, the overall stability is enhanced, and it suits the different use habits of users. Thus, the operability and convenience are greatly enhanced.

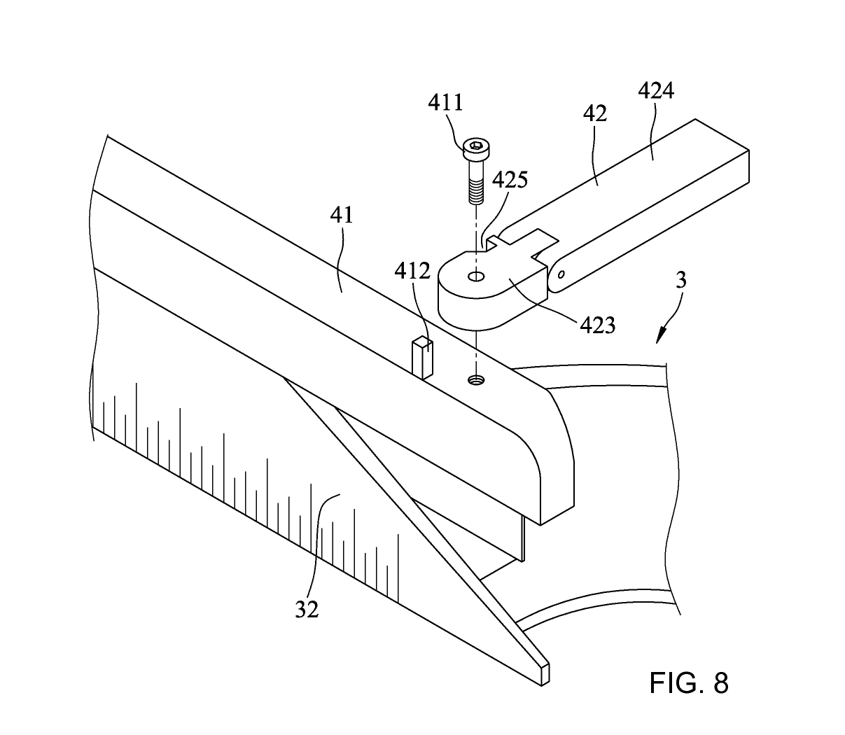

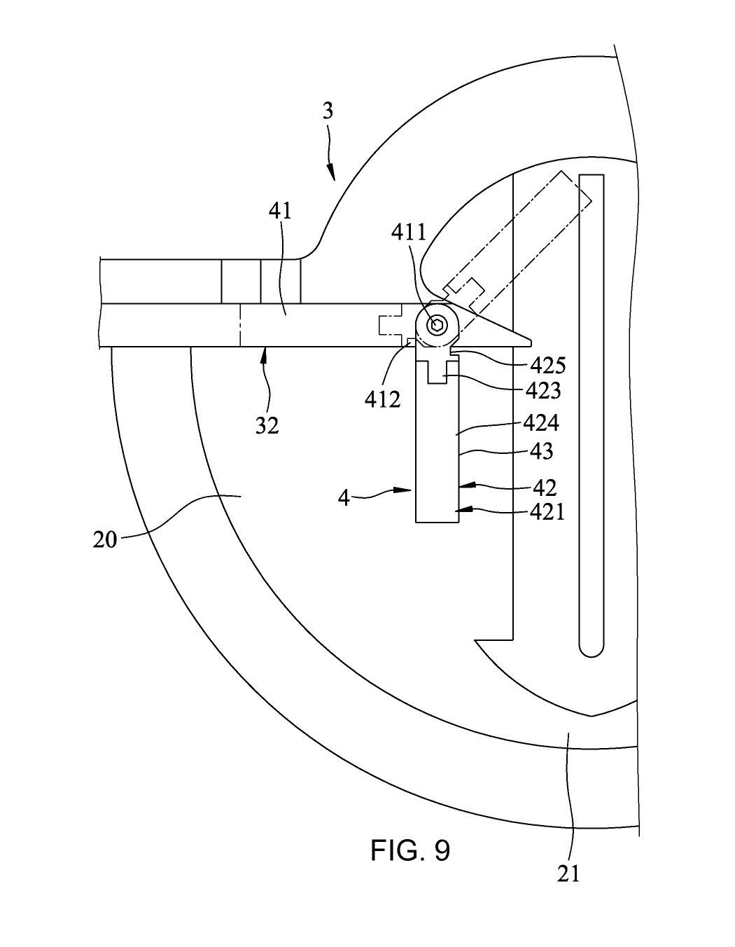

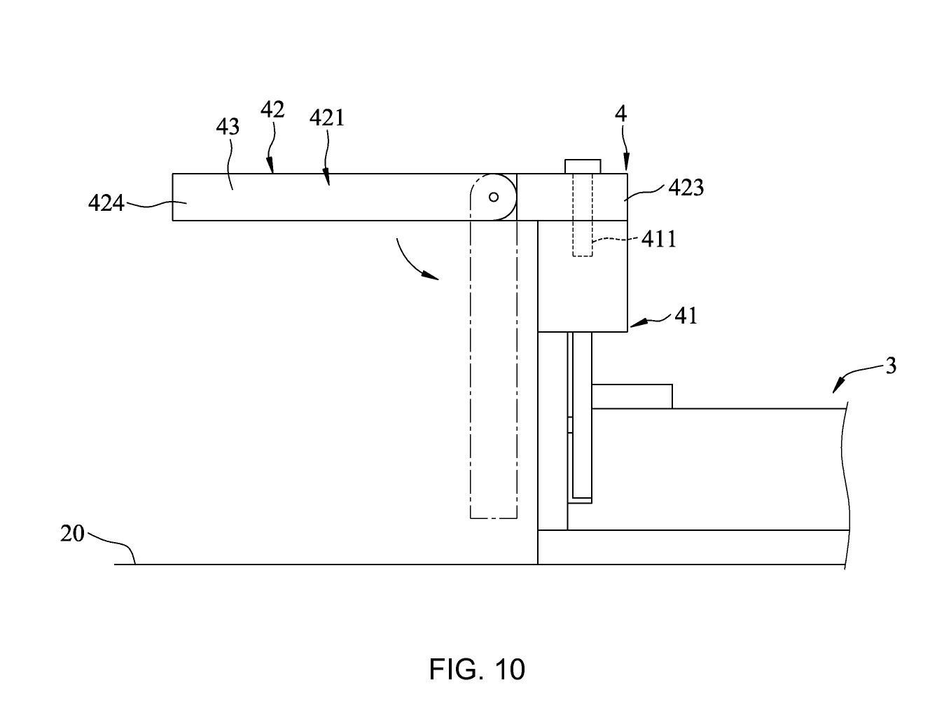

With reference to FIGS. 8-10, a second embodiment of the present invention is shown. The elements and effects of the second embodiment which are the same as the first embodiment are not described, only the differences are described. In this embodiment, each fixing member 41 of the auxiliary positioning device 4 has a locking post 411, and a limiting stud 412 is disposed on a top of the fixing member 41. The positioning post 42 is pivotally mounted to the fixing member 41 via the locking post 411. A notch 425 is defined in the coupling member 423 of the positioning post 42. The notch 425 is located adjacent to the fixing member 41.

In the extended configuration, the positioning post 42 is extended toward the front portion 21 of the worktable 20, and protrudes from the panel 32. The positioning post 42 abuts against the limiting stud 412 such that the positioning post 42 is properly positioned. In the collapsed configuration, the positioning post 42 is retracted, the column member 421 of the positioning post 42 is folded and is parallel to the panel 32. The notch 425 of the fixing post 42 engages with the limiting stud 412.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fence with auxiliary positioning device for a saw machine, adapted for mounting to a worktable of the circular saw, the worktable including a plane for supporting a workpiece, and the worktable having a front portion and a rear portion, the fence with auxiliary positioning device comprising:
a base disposed on the rear portion of the worktable, the base having at least one panel disposed thereon, the panel having a first planar surface formed thereon, the first planar surface extending toward the front portion and being perpendicular to the plane of the worktable; and
at least one auxiliary positioning device having a fixing member disposed on the base and parallely slidable relative to the first planar surface, and a positioning post disposed on the fixing member;
wherein the positioning post is convertible relative to the panel between an extended configuration and a collapsed configuration, wherein in the extended configuration, the positioning post is oriented toward the front portion and extends beyond the first planar surface such that a second planar surface which is perpendicular to the first planar surface is formed on the positioning post, and wherein in the collapsed configuration, the positioning post is retracted and oriented toward the rear portion of the worktable such that the positioning post does not extend beyond the first planar surface.

2. A fence with auxiliary positioning device for a saw machine as claimed in claim 1, wherein the panel of the base includes a lower panel and an upper panel slidably disposed on the lower panel adapted for accommodating the fixing member, and a locking member disposed on the base for selectively fixing the upper panel to the lower panel, such that the upper panel and the lower panel together form the first planar surface.

3. A fence with auxiliary positioning device for a saw machine as claimed in claim 2, wherein the base includes two panels which are spacedly arranged, the first planar surfaces of each panel are co-planar, and the fixing members are respectively disposed on the upper panels.

4. A fence with auxiliary positioning device for a saw machine as claimed in claim 1, wherein the fixing member of the auxiliary positioning device includes a locking post, the positioning post is slidably mounted to the fixing member, and the positioning post includes a column member having a positioning slot longitudinally defined therein for slidably accommodating the locking post.

5. A fence with auxiliary positioning device for a saw machine as claimed in claim 4, wherein the locking post is a threaded bolt.

6. A fence with auxiliary positioning device for a saw machine as claimed in claim 1, wherein the fixing member of the auxiliary positioning device includes a locking post for pivotally mounting the auxiliary positioning device to the fixing member;
wherein, in the extended configuration, the positioning post is extended toward the front portion of the worktable, and in the collapsed configuration, the positioning post is parallel to the panel.

7. A fence with auxiliary positioning device for a saw machine as claimed in claim 6, wherein the fixing member has a limiting stud disposed on a top thereof for restraining the positioning post in the extended configuration, and the positioning post has a notch defined therein and located adjacent to the fixing member;
wherein in the collapsed configuration, the notch engages with the limiting stud.

8. A fence with auxiliary positioning device for a saw machine as claimed in claim 1, wherein the positioning post of the auxiliary positioning device includes a coupling member disposed on the fixing member, and a blocking member pivotally engaged to the coupling member;
wherein in the extended configuration, the blocking member is pivotally rotatable relative to the coupling member between a first position and a second position, such that the blocking member extends from the coupling member and is located away from the worktable when the blocking member is at the first position, and the blocking member is perpendicular to the coupling member and is located proximate to the panel and the worktable when the blocking member is at the second position.
